(19) United States
(12) Patent Application Publication
(10) Pub. No.: US 2021/0136500 A1
(43) Pub. Date: May 6, 2021

(54) SCREEN SOUNDING EXCITER AND ELECTRONIC DEVICE

(71) Applicant: AAC Technologies Pte. Ltd., Singapore city (SG)

(72) Inventors: Huan Ge, Shenzhen (CN); Lubin Mao, Shenzhen (CN)

(21) Appl. No.: 16/996,916

(22) Filed: Aug. 19, 2020

(30) Foreign Application Priority Data
Oct. 31, 2019 (CN) 201911053287.3

(51) Int. Cl. H04R 11/02; H04R 9/02; H04R 9/06; H04M 1/02; H04R 9/04

(52) U.S. Cl. CPC H04R 11/02; H04R 9/025; H04R 9/06; H04R 1/028; H04R 9/045; H04R 2400/11; H04M 1/0266

(57) ABSTRACT

The invention discloses a screen sounding exciter and an electronic device. The screen sounding exciter includes a first magnetic circuit system, an electromagnetic driving system, and a second magnetic circuit system which are sequentially arranged along the vibrating direction of the display screen from top to bottom. The first magnetic circuit system is fixed on a display screen, and the electromagnetic driving system is fixed on a back cover. The exciter further includes an elastic member whose one end is connected to the second magnetic circuit system to elastically support the second magnetic circuit system and the other end is fixed on the electromagnetic drive system.

### FIELD OF THE PRESENT INVENTION

The invention relates to a field of acoustics technology, and more particularly to a screen sounding exciter and an electronic device.

### DESCRIPTION OF RELATED ART

At present, there are mainly two types of screen sounding exciters in mobile phones. One type is a piezoceramic unit exciter, a multi-layer piezoceramic sheets are attached to a metal thin section, which is called a vibrating diaphragm. When the vibrating diaphragm is supplied with an alternating voltage, the vibrating diaphragm will continuously bend up and down as the voltage changes so as to drive the load structure to vibrate and sound. The other type is a micro-vibrating unit exciter, which can generate a force field by using an interaction of the electric field and the magnetic field.

### SUMMARY OF THE PRESENT INVENTION

The purpose of the present invention is to provide a screen sounding exciter and an electronic device which can enhance or eliminate the vibrating effect of the back cover.

In one aspect of the present disclosure, a screen sounding exciter applied to an electronic device, the electronic device including a display screen driven by the exciter to generate sound, and a back cover forming a receiving space together with the display screen. The screen sounding exciter includes a first magnetic circuit system, an electromagnetic driving system, and a second magnetic circuit system, which are sequentially arranged along a vibrating direction of the display screen from top to bottom. The first magnetic circuit system is fixed to the display screen, and the electromagnetic driving system is fixed to the back cover. The screen sounding exciter further includes an elastic member, one end of the elastic member is connected to the second magnetic circuit system to elastically support the second magnetic circuit system and the other end of the elastic member is fixed to the electromagnetic drive system.

Furthermore, the first magnetic circuit system includes a screen connecting plate and a first magnet, one side of the screen connecting plate is fixed to the display screen; and the first magnet fixed on the other side of the screen connecting plate.

In some embodiment, the electromagnetic driving system includes a supporting frame fixed on the back cover, a voice coil fixed on the supporting frame, and an iron core inserted in a hollow position of the voice coil. A first vibrating gap is formed between the first magnet and the iron core and a second vibrating gap is formed between the second magnet and the iron core.

Furthermore, the second magnetic circuit system includes a mass block connected to the supporting frame through an elastic member and a second magnet fixed in a hollow position of the mass block.

Furthermore, the elastic member includes a first connecting portion fixed to the supporting frame, a second connecting portion fixed to the mass block, and a spring connected between the first connecting portion and the second connecting portion.

Furthermore, the supporting frame includes a first frame body fixing the voice coil and a second frame body fixed on the back cover. The first connecting portion is sandwiched between the first frame body and the second frame body.

Furthermore, the first connecting portion is a first ring-shaped connecting piece matched with an outer edge of the first frame body and an outer edge of the second frame body. The second connecting portion is a second ring-shaped connecting piece matched with an outer edge of the mass block. The second ring-shaped connecting piece is mounted in a hollow groove of the first ring-shaped connecting piece through the spring.

Furthermore, both the first magnet and the second magnet are permanent magnets, and the polarities of the first magnet and the second magnet are arranged in the same direction.

Furthermore, both the first magnet and the second magnet are permanent magnets, and the polarities of the first magnet and the second magnet are arranged in opposite direction.

In another aspect, the present disclosure provides an electronic device, which includes a display screen, a middle frame for fixing the display screen, a back cover mounted to the middle frame, and a battery accommodated in the middle frame. The electronic device further includes at least one screen sounding exciter mounted on the back cover and connected to the display screen. The screen sounding exciter includes a first magnetic circuit system, an electromagnetic driving system, and a second magnetic circuit system, which are sequentially arranged along a vibrating direction of the display screen from top to bottom. The first magnetic circuit system is fixed to the display screen, and the electromagnetic driving system is fixed to the back cover. The screen sounding exciter further includes an elastic member, one end of the elastic member is connected to the second magnetic circuit system to elastically support the second magnetic circuit system and the other end of the elastic member is fixed to the electromagnetic drive system.

The advantages of present disclosure are detailed as following: with configuration of the screen sounding exciter, a magnetic circuit system is divided into a first magnetic circuit system and a second magnetic circuit system, which are formed a first vibrating gap and a second vibrating gap with an electromagnetic driving system respectively. The first magnetic circuit system is connected with the display screen, so that the display screen can be driven to generate sound under the influence of the electromagnetic field of the electromagnetic driving system. The electromagnetic driving system is connected with the back cover so that the first magnetic circuit system can be interacted with the second magnetic circuit system to eliminate or enhance the vibrating effect of the electromagnetic driving system, thus to enhance or eliminate the vibrating effect of the back cover.

### BRIEF DESCRIPTION OF THE DRAWINGS

FIG. 1 is a perspective structural view of an electronic device according to an embodiment of the present invention.

FIG. 2 is a cross-sectional view of the electronic device taken along line A-A in FIG. 1 according to the embodiment of the present invention.

FIG. 3 is a structural view of an screen sounding exciter according to the embodiment of the present invention.

FIG. 4 is a perspective exploded view of the screen sounding exciter according to the embodiment of the present invention.

FIG. 5 is a cross-sectional view of the screen sounding exciter taken along line B-B in FIG. 3 according to the embodiment of the present invention.

FIG. 6 is a structural view of an elastic member according to the embodiment of the present invention.

FIG. 7 is a schematic view of a first magnetic polarity relationship of the screen sounding exciter according to the embodiment of the present invention.

FIG. 8 is a schematic view of a second magnetic polarity relationship of the screen sounding exciter according to the embodiment of the present invention.

FIG. 9 is a schematic view of a third magnetic polarity relationship of the screen sounding exciter according to the embodiment of the present invention.

FIG. 10 is a schematic view of a fourth magnetic polarity relationship of the screen sounding exciter according to the embodiment of the present invention.

### DETAILED DESCRIPTION OF THE EXEMPLARY EMBODIMENT

The present invention will be further described below with reference to the drawings and embodiments.

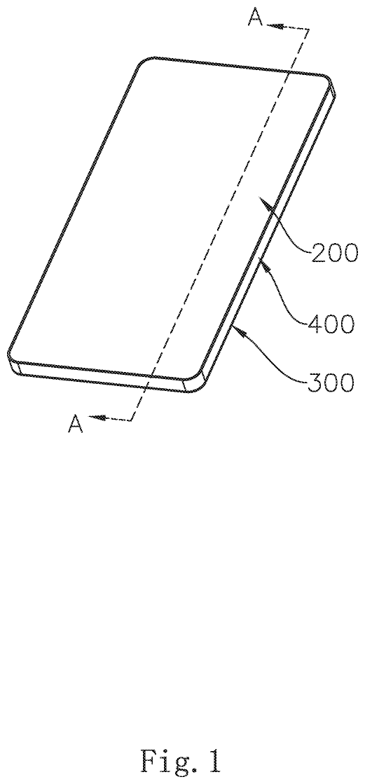

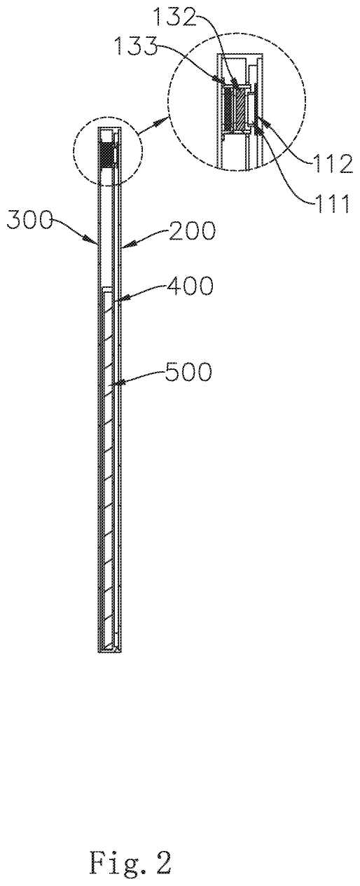

Please refer to FIG. 1 to FIG. 2, the present invention discloses an electronic device, including a display screen 200, a middle frame 400 fixing the display screen 200, a back cover 300 fixed to the middle frame 400, a battery 500 accommodated in the middle frame 400, and at least one screen sounding exciter 100 provided on the back cover 300 and fixedly connected with the display screen 200. There is no direct connection between the middle frame 400 and the screen sounding exciter 100. The middle frame 400 is provided with a plurality of through holes 410 for the screen sounding exciter 100 passing through thereof to fix on the back cover 300.

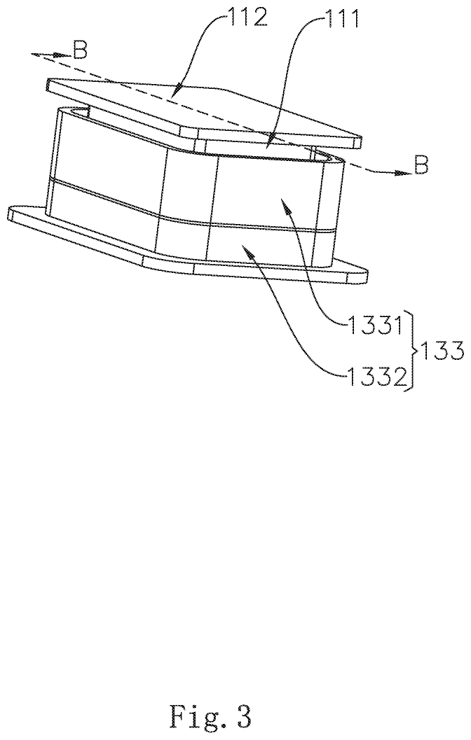

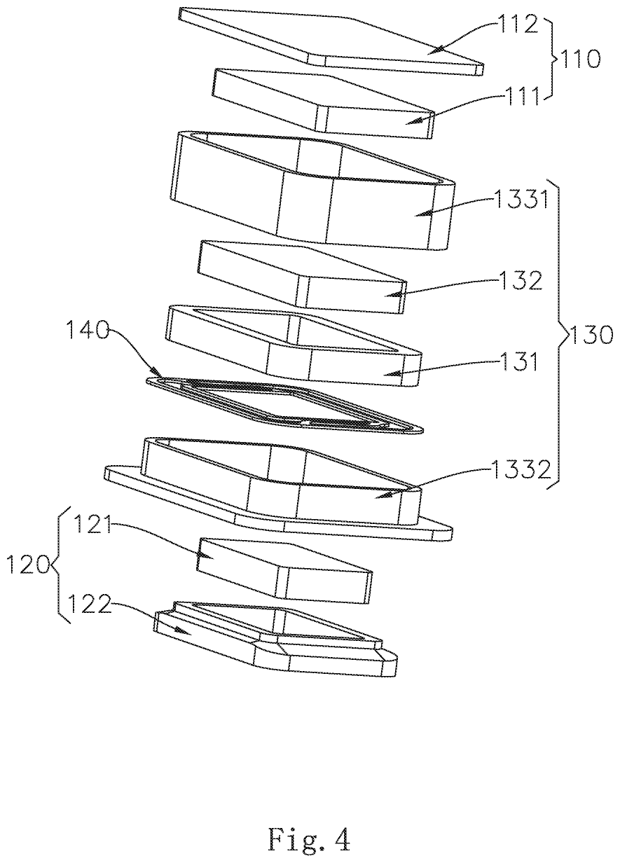

Please further refer to FIG. 1 through FIG. 5, the screen sounding exciter 100 includes a first magnetic circuit system 110, an electromagnetic driving system 130, and a second magnetic circuit system 120 which are sequentially arranged along a vibrating direction of the display screen 200 from top to bottom. The first magnetic circuit system 110 is fixed to the display screen 200, and the electromagnetic driving system 130 is fixed to the back cover 300. The screen sounding exciter 100 further includes an elastic member 140, one end of the elastic member 140 is connected to the second magnetic circuit system 120 to elastically support the second magnetic circuit system 120 and the other end of the elastic member 140 is fixed to the electromagnetic driving system 130. A first vibrating gap 113 is formed between the bottom of the first magnetic circuit system 110 and the top of the electromagnetic driving system 130, and a second vibrating gap 123 is formed between the top of the second magnetic circuit system 120 and the bottom of the electromagnetic driving system 130.

Compared to the prior art, with the configuration of the screen sounding exciter 100 of the present disclosure, the magnetic circuit system is divided into the first magnetic circuit system 110 and the second magnetic circuit system 120, which defines the first vibrating gap 113 and the second vibrating gap 123 with the electromagnetic driving system 130 respectively. The first magnetic circuit system 110 is connected to the display screen 200, so that the display screen 200 can be driven to generate sound under the influence of the electromagnetic field of the electromagnetic driving system 130. The electromagnetic driving system 130 is connected to the back cover 300, so that the first magnetic circuit system 110 can be interacted with the second magnetic circuit system 120 to cancel or enhance the vibrating effect of the electromagnetic driving system 130, thus to enhance or eliminate the vibrating effect of the back cover.

In the present embodiment, the first magnetic circuit system 110 includes a screen connecting plate 112 and a first magnet 111. One side of the screen connecting plate 112 is fixed on the display screen 200, the first magnet 111 is fixed on the other side of the screen connecting plate 112. One side of the screen connecting plate 112 is in contact with an inner surface of the display screen 200, and the other side of the screen connecting plate 112 is fixed to the first magnet 111. When the first magnet 111 is affected by the electromagnetic field of the electromagnetic driving system 130, the display screen 200 is driven to vibrate and sound in the first vibrating gap 113.

In the present embodiment, the second magnetic circuit system 120 includes a mass block 122 connected to a supporting frame 133 through the elastic member 140 and a second magnet 121 fixed in a hollow position of the mass block 122. The mass block 122 is configured to fix the second magnet 121, and has a certain weight to provide a certain reactive force to the electromagnetic driving system 130.

In the present embodiment, the electromagnetic driving system 130 includes the supporting frame 133 fixed on the back cover 300, a voice coil 131 fixed on the supporting frame 133, and an iron core 132 inserted in a hollow position of the voice coil 131. The first vibrating gap 113 is formed between the first magnet 111 and the iron core 132, and the second vibrating gap 123 is formed between the second magnet 121 and the iron core 132. The voice coil 131 is electrically connected to the control mainboard of the electronic device. An electromagnetic field centered on the iron core 132 is formed after a current is flowed into the voice coil 131. The iron core 132 generates opposite poles together with two opposite ends of the first magnet 111 and the second magnet 121 respectively. Due to the action of the electromagnetic field, the first magnet 111 and the second magnet 121 generate vibrating effects respectively.

Referring to FIG. 6, the elastic member 140 includes a first connecting portion 141 fixedly connected to the supporting frame 133, a second connecting portion 142 mounted to the mass block 122, and a spring 143, one end of the spring 143 is connected to the first connecting portion 141 and the other end of the spring 143 is connected to the second the connecting portion 142.

In the present embodiment, the supporting frame 133 includes a first frame body 1331 for fixing the voice coil 131 and a second frame body 1332 fixed on the back cover 300. The first connecting portion 141 is sandwiched between the first frame body 1331 and the second the frame body 1332. The first frame body 1331 is fixed to the second frame body 1332, and the first connecting portion 141 is fixed.

In the present embodiment, the first connecting portion 141 is a first ring-shaped connecting piece matched with an outer edge of the first frame body 1331 and an outer edge of the second frame body 1332. Both sides of the first ring-shaped connecting piece are seamlessly bonded with the edge of the first frame body 1331 and the edge of the second frame body 1332 by glue. The second connecting portion 142 is a second ring-shaped connecting piece matched with an outer edge of the mass block 122. One side of the second ring-shaped connecting piece is seamlessly bonded with the edge of the mass block 122 by glue, and the second ring-shaped connecting piece is fixed in a hollow groove of the first ring-shaped connecting piece through the springs 143. An outer diameter of the first ring-shaped connecting piece is larger than that of the second ring-shaped connecting piece. Under the influence of the electromagnetic field, the spring 143 is bent, so that the first ring-shaped connecting piece and the second ring-shaped connecting piece vibrate at different height positions. The spring 143 has a straight or curved elastic sheet structure with ductility. The number of the springs 143 is determined according to the specific shapes of the first ring-shaped connecting piece and the second ring-shaped connecting piece.

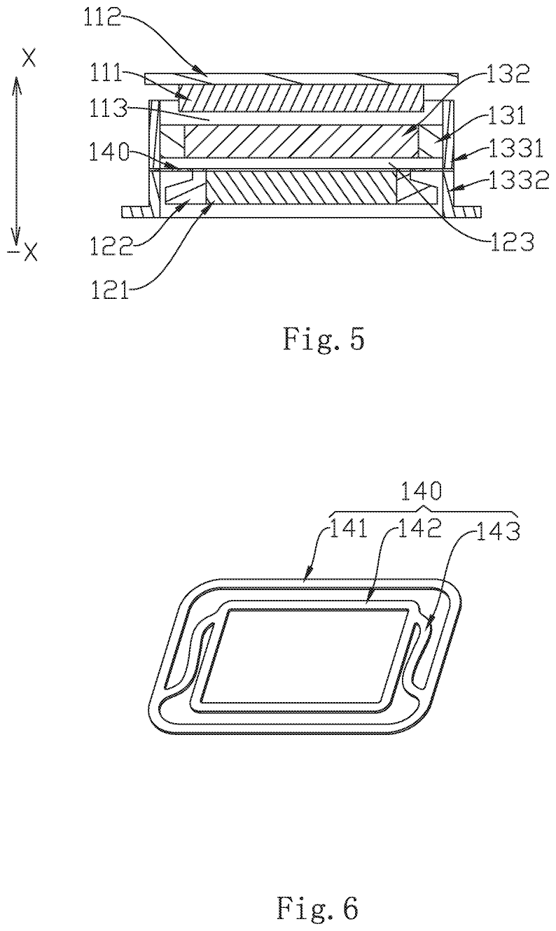

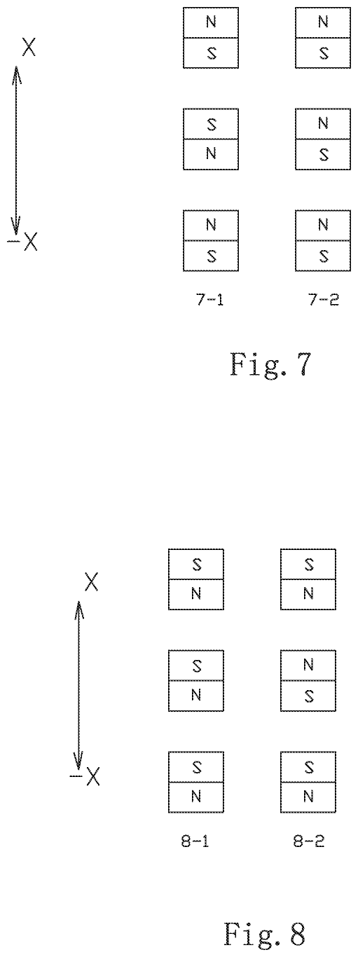

Referring to FIG. 5, FIG. 7 and FIG. 8, the first magnet 111 and the second magnet 121 are both permanent magnets, and a polarity direction arrangement of the first magnet 111 is the same as that of the second magnet 121. In the embodiment, a term “upward” means that a direction toward X, and a term “downward” means that a direction toward −X. As shown in FIG. 7, the N pole of the first magnet 111 and the second magnet 121 are both facing upward and the S poles are both facing downward. When the current is applied to the coil so that the S pole of the iron core 132 of the electromagnetic driving system 130 is facing upward and the N pole of the iron core 132 is facing downward (as shown in FIG. 7-1), the mutual repulsive forces are generated between the first magnet 111 and the iron core 132, and the second magnet 121 and the iron core 132, respectively. The directions of the two repulsive forces are opposite, which can be canceled each other, thereby weakening the vibration of the electromagnetic driving system 130, thus to reduce the vibration effect of the back cover 300. When the current is applied to the coil so that the S pole of the iron core 132 of the electromagnetic driving system 130 faces downward and the N pole of the iron core 132 faces upward (as shown in FIG. 7-2). The attractive force is generated between the first magnet 111 and the iron core 132, and the attractive force is also generated between the second magnet 121 and the iron core 132. The directions of the two attractive forces are opposite, which can be canceled each other, thus to weaken the vibration of the electromagnetic driving system 130, thereby reducing the vibrating effect of the back cover 300. As shown in FIG. 8, the S pole of the first magnet 111 and the second magnet 121 both face upward, and the N poles face downward. The functional principle of FIG. 8-2 is similar to that of FIG. 7-1, and the functional principle of FIG. 8-1 is similar to that of FIG. 7-2. The effects are the same thereof, and details are not described herein again.

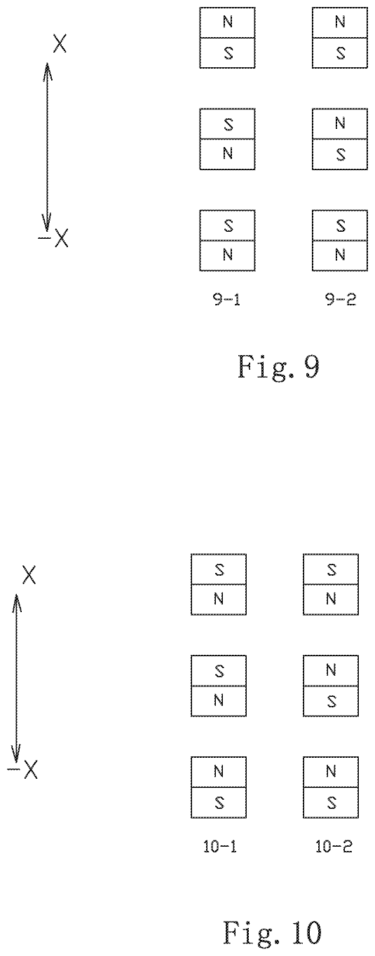

Please further refer to FIG. 5, FIG. 9 and FIG. 10, the first magnet 111 and the second magnet 121 are both permanent magnets, and a polarity direction arrangement of the first magnet 111 is opposite to that of the second magnet 121. In the embodiment, the term “upward” means that a direction toward X, and the term “downward” means that a direction toward −X.

As shown in FIG. 9, the N pole of the first magnet 111 faces upward and the S pole faces downward. The S pole of the second magnet 121 faces upward and the N pole faces downward. When the current is applied to the coil so that the S pole of the iron core 132 of the electromagnetic driving system 130 faces upward and the N pole of the iron core 132 faces downward (as shown in FIG. 9-1). A mutual repulsive force is generated between the first magnet 111 and the iron core 132, and a mutual attractive force is generated between the first magnet 111 and the iron core 132. The direction of the repulsive force applied to the iron core 132 is the same as the direction of the attractive force applied to the iron core 132 at this time. The two interaction forces can be superimposed on each other to enhance the vibrating of the electromagnetic drive system 130, thereby enhancing the vibrating effect of the back cover 30. Therefore, the vibrating effect of the back cover 300 is enhanced to cause it to vibrate together with the screen. When the current is applied to the coil so that the S pole of the iron core 132 of the electromagnetic driving system 130 faces downward and the N pole of the iron core 132 faces upward (as shown in FIG. 9-2). A mutual attractive force is produced between the first magnet 111 and the iron core 132, and a mutual repulsive force is produced between the second magnet 121 and the iron core 132. The direction of the attractive force applied to the iron core 132 is the same as the direction of the repulsive force applied to the iron core 132 at this time, so the two interaction forces can be superimposed on each other to enhance the vibrating of the electromagnetic driving system 130, thereby enhancing the vibrating effect of the back cover 300. Therefore, the vibrating effect of the back cover 300 is enhanced to cause it to vibrate together with the screen. As shown in FIG. 10, the S pole of the first magnet 111 faces upward and the N pole faces downward. The N pole of the second magnet 121 faces upward and the S pole faces downward. The functional principle in FIG. 10-2 is similar to that in FIG. 9-1, and the functional principle in FIG. 10-1 is similar to that in FIG. 9-2. The effects are the same thereof, and details are not described herein again.

In summary, with the different designs of the magnets in the device of the present invention, two different effects during the working process of the screen sounding mobile phone can be achieved. One is to cancel the vibration of the back cover to improve the users' griping experience, and the other is to increase the vibration of the back cover to drive it to generate sound together with the screen at the same time, thus to improve the sound effect.

The above description is only preferred embodiment of the present invention, and it should be noted that those skilled in the art can also make improvements without departing from the inventive concept of the present invention, but these improvements all belong to the protection scope of the invention.

What is claimed is:

1. A screen sounding exciter applied to an electronic device, the electronic device comprising a display screen driven by the screen sounding exciter to generate sound, and a back cover forming a receiving space together with the display screen; wherein,
the screen sounding exciter comprises a first magnetic circuit system, an electromagnetic driving system, and a second magnetic circuit system which are sequentially arranged along a vibrating direction of the display screen from top to bottom; the first magnetic circuit system is fixed on the display screen, and the electromagnetic driving system is fixed on the back cover;
the screen sounding exciter further comprises an elastic member, one end of the elastic member is connected to the second magnetic circuit system to elastically support the second magnetic circuit system and the other end of the elastic member is fixed on the electromagnetic drive system.

2. The screen sounding exciter according to claim 1, wherein the first magnetic circuit system comprises a screen connecting plate, and a first magnet, one side of the screen connecting plate is fixed on the display screen; and the first magnet is fixed on the other side of the screen connecting plate.

3. The screen sounding exciter according to claim 2, wherein the electromagnetic driving system includes a supporting frame fixed on the back cover, a voice coil fixed on the supporting frame, and an iron core inserted in a hollow position of the voice coil.

4. The screen sounding exciter according to claim 3, wherein the second magnetic circuit system includes a mass block connected to the supporting frame through the elastic member and a second magnet fixed in a hollow position of the mass block.

5. The screen sounding exciter according to claim 4, wherein the elastic member includes a first connecting portion fixedly connected to the supporting frame, a second connecting portion fixedly connected to the mass block, and a spring connected between the first connecting portion and the second connecting portion.

6. The screen sounding exciter according to claim 5, wherein the supporting frame includes a first frame body for fixing the voice coil and a second frame body fixed on the back cover, and the first connecting portion is sandwiched between the first frame body and the second frame body.

7. The screen sounding exciter according to claim 5, wherein the first connecting portion is a first ring-shaped connecting piece matched with an outer edge of the first frame body and an outer edge of the second frame body, and the second connecting portion is a second ring-shaped connecting piece matched with an outer edge of the mass block; the second ring-shaped connecting piece is fixed in a hollow groove of the first ring-shaped connecting piece through the spring.

8. The screen sounding exciter according to claim 4, wherein both the first magnet and the second magnet are permanent magnets, and the polarities of the first magnet and the second magnet are arranged in the same direction.

9. The screen sounding exciter according to claim 4, wherein both the first magnet and the second magnet are permanent magnets, and the polarities of the first magnet and the second magnet are arranged in opposite direction.

10. An electronic device, comprising a display screen, a middle frame fixed the display screen, a back cover fixedly connected to the middle frame, and a battery accommodated in the middle frame, wherein, the electronic device further includes at least one screen sounding exciter arranged on the back cover and connected to the display screen; wherein,
the screen sounding exciter comprises a first magnetic circuit system, an electromagnetic driving system, and a second magnetic circuit system which are sequentially arranged along a vibrating direction of the display screen from top to bottom; the first magnetic circuit system is fixed on the display screen, and the electromagnetic driving system is fixed on the back cover;
the screen sounding exciter further comprises an elastic member, one end of the elastic member is connected to the second magnetic circuit system to elastically support the second magnetic circuit system and the other end of the elastic member is fixed on the electromagnetic drive system.

11. The electronic device according to claim 10, wherein the first magnetic circuit system comprises a screen connecting plate, and a first magnet, one side of the screen connecting plate is fixed on the display screen; and the first magnet is fixed on the other side of the screen connecting plate.

12. The electronic device according to claim 11, wherein the electromagnetic driving system includes a supporting frame fixed on the back cover, a voice coil fixed on the supporting frame, and an iron core inserted in a hollow position of the voice coil.

13. The electronic device according to claim 12, wherein the second magnetic circuit system includes a mass block connected to the supporting frame through the elastic member and a second magnet fixed in a hollow position of the mass block.

14. The electronic device according to claim 13, wherein the elastic member includes a first connecting portion fixedly connected to the supporting frame, a second connecting portion fixedly connected to the mass block, and a spring connected between the first connecting portion and the second connecting portion.

15. The electronic device according to claim 14, wherein the supporting frame includes a first frame body for fixing the voice coil and a second frame body fixed on the back cover, and the first connecting portion is sandwiched between the first frame body and the second frame body.

16. The electronic device according to claim 14, wherein the first connecting portion is a first ring-shaped connecting piece matched with an outer edge of the first frame body and an outer edge of the second frame body, and the second connecting portion is a second ring-shaped connecting piece matched with an outer edge of the mass block; the second ring-shaped connecting piece is fixed in a hollow groove of the first ring-shaped connecting piece through the spring.

17. The electronic device according to claim 13, wherein both the first magnet and the second magnet are permanent magnets, and the polarities of the first magnet and the second magnet are arranged in the same direction.

18. The electronic device according to claim 13, wherein both the first magnet and the second magnet are permanent magnets, and the polarities of the first magnet and the second magnet are arranged in opposite direction.
